(19) United States
(12) Patent Application Publication
(10) Pub. No.: US 2024/0186596 A1
(43) Pub. Date: Jun. 6, 2024

(54) PRESSURIZING SYSTEM FOR AN ALL-SOLID-STATE BATTERY

(71) Applicants: HYUNDAI MOTOR COMPANY, Seoul (KR); KIA CORPORATION, Seoul (KR)

(72) Inventors: Jae Ho Shin, Seoul (KR); Young Jin Nam, Seoul (KR); Min Sun Kim, Goyang-si (KR); Ga Young Choi, Busan (KR); Yong Seok Choi, Seoul (KR); Yong Guk Gwon, Hwaseong-si (KR)

(73) Assignees: HYUNDAI MOTOR COMPANY, Seoul (KR); KIA CORPORATION, Seoul (KR)

(21) Appl. No.: 18/509,895

(22) Filed: Nov. 15, 2023

(30) Foreign Application Priority Data
Dec. 5, 2022 (KR) 10-2022-0167272

(51) Int. Cl. H01M 10/42; H01M 10/44

(52) U.S. Cl. CPC H01M 10/4285; H01M 10/44; H01M 10/0562

(57) ABSTRACT

A pressurizing system capable of actively varying and adjusting the pressure applied to a cell of an all-solid-state battery includes: a pressurizing mechanism provided to pressurize an all-solid-state battery and driven to adjust and vary the pressure applied to the all-solid-state battery; a driving device operated to drive the pressurizing mechanism; and a controller controlling the operation of the driving device so that the pressure to pressurize the all-solid-state battery can be adjusted and varied by the above pressurizing mechanism. When the all-solid-state battery is charged or discharged, the controller controls the operation of the driving device based on a pressure change rate so that the pressure for pressurizing the all-solid-state battery may be adjusted and varied according to the pressure change rate determined based on the state information of the all-solid-state battery.

The present application claims priority to Korean Patent Application No. 10-2022-0167272, filed Dec. 5, 2022, the entire contents of which are incorporated herein for all purposes by this reference.

### BACKGROUND

### 1. Field

The present disclosure relates to a pressurizing system for an all-solid-state battery. More particularly, the present disclosure relates to a dynamic pressurizing system capable of actively and variably controlling the pressure applied to an all-solid-state battery.

### 2. Description of the Related Art

The statements in this section merely provide background information related to the present disclosure and may not constitute prior art.

A secondary battery is a rechargeable energy storage device. Secondary batteries are widely used as a power source for vehicles such as hybrid vehicles and electric vehicles, as well as small electronic devices such as mobile phones and laptop computers.

Conventional secondary batteries have limitations in improving stability and energy density because most of the cells are manufactured using organic solvents, which are liquid electrolytes. In recent years, the development of an all-solid-state battery using an inorganic solid electrolyte has been actively conducted.

In general, an all-solid-state battery cell is composed of a three-layer stacked product in which a cathode active material layer bonded to a cathode current collector, an anode active material layer bonded to the anode current collector, and a solid electrolyte layer positioned between the cathode active material layer and the anode active material layer, are stacked.

As described herein, all-solid-state batteries using solid electrolytes are based on a technology excluding an organic solvent. Thus such an all-solid-state battery cell can be manufactured more safely and simply, attracting great attention in recent years.

For example, research on the use of all-solid-state batteries as batteries for electric vehicles is being actively conducted. All-solid-state batteries with high energy density are required to ensure the mileage and safety of electric vehicles.

Graphite may be used as the anode of an all-solid-state battery. In this case, ion conductivity may be ensured only when an excessive amount of a solid electrolyte having a high specific gravity is added together with graphite, and thus energy density per weight is very low. In addition, in the case of an all-solid-state battery using lithium (Li) metal as an anode, the all-solid-state battery has technical limitations in price competitiveness and size.

One of the alternatives to overcome these limitations is to apply a lithium-free anode technology. Applying a lithium-free anode technology is advantageous in securing high energy density, processability, and price competitiveness.

However, when the lithium-free anode technology is applied, there is a problem in that the battery expands and contracts due to electroplating and desorption of lithium metal during charging and discharging. As a result, structural degradation of the battery may progress.

In order to prevent such structural deterioration and ensure uniformity of lithium electroplating, physical pressurization is required for a battery. Additionally, a physical pressurizing device is required to pressurize a cell stack in a state in which a plurality of cells is stacked in a multilayer state and to maintain the pressurization state.

In lithium-free all-solid-state batteries, an optimal pressure condition suitable for the required performance (capacity per area) of a cell is required due to high pressure dependence. In particular, an electroplating thickness of lithium (Li) is changed according to a state of charge (SOC). Thus a pressure condition suitable for a charge state is required.

A pressurizing jig is known as a pressurizing device for an all-solid-state battery. The pressurizing jig includes two jig plates stacked with a pad interposed between both surfaces of a cell stack and a fastening mechanism for fastening and fixing the two jig plates to each other.

The fastening mechanism may include bolts and nuts fastened through each corner of the two jig plates. More specifically, the fastening mechanism may include four bolts and nuts fastened to pass through four corner parts of the rectangular jig plate.

Since the conventional pressurizing jig always pressurizes the cell stack with a fixed force, the volume of a cell, particularly the thickness of the cell, is greatly changed according to the charging and discharging state of the battery. When the thickness of the cell is greatly changed, the change in pressure that is acting between the pressurizing jig and the cell may also be significantly changed.

Accordingly, it is desirable to flexibly control the pressure applied by the pressurizing jig according to the charging and discharging state of the all-solid-state battery so that the cell may always receive a pressure within a suitable range regardless of the changes in volume and thickness of the cell in the all-solid-state battery.

In addition, since pressure is mainly applied to the cell only through the four pressure points to which the fastening mechanism is coupled, a greater pressure is applied to the area around the pressure points in the cell. Thus, it is difficult to apply uniform pressure to the entire area of the cell.

In addition, pads are used to relieve pressure due to the volume (thickness) expansion of the cell. The characteristics of the cell may change significantly depending on the physical properties of the pad. Additionally, the physical properties of the pad may have limitations in the pressure relief effect.

In addition, when the all-solid-state battery operates at a high temperature after the jig plate of the pressurizing jig is fastened at room temperature, the initial pressure applied to the all-solid-state battery may be rapidly increased due to the volume expansion of the pad. Furthermore, the overall pressure may be decreased due to screw loosening of the fastening mechanism or changes in the physical properties of the pad during long-term use.

In addition, steps and cracks in the edge portion of the cell, cracks in the anode current collector, and the like may occur. Such issues are described in detail with reference to FIGS. 1 and 2.

FIG. 1 is a view explaining the charging and discharging process of a lithium-free all-solid-state battery. The view shows the charging and discharging state of the cell.

During charging, lithium ions (Li⁺) are transferred from a cathode, which is a lithium source, to an anode by an electric field. The lithium ions transferred through a solid electrolyte (SE) are reduced to a metal form at the anode and electroplated on an anode current collector. The thickness of the cell increases due to the electroplating of lithium metal.

During discharging, the electroplated lithium metal deposited during charging is oxidized in the form of ions and transferred to the cathode by an electric field. Thus, lithium ions are intercalated and stored in the crystal structure of the active material. Thus, the thickness of the cell is reduced.

FIG. 2 is a view explaining problems of a known lithium-free all-solid-state battery. The view shows a state in which an evaluation jig is fastened to the cell. Specifically, the view shows a state before and after charging the cell 1 in which the jig plates (3A and 3B) are fastened while the pads (2A and 2B) are positioned therebetween.

In order to maintain interfacial contact between the cathode active material layer 1A, the electrolyte layer 1B, and the anode active material layer 1C, a pressurizing device, as shown in FIG. 2, is required. The conventional pressurizing device is a static system, and the pressurizing pressure applied to the cell 1 by the pressurizing device is fixed to a value set at the time of fastening the jig plates 3A and 3B. In other words, according to the conventional pressurizing device, it is impossible to change the pressure applied to the cell in real-time even though the thickness of the cell 1 varies depending on the state of charge (SOC).

As a result, as charging and discharging are repeated, expansion and contraction of the cell volume are repeated, and the cell thickness is repeatedly increased and decreased. The repeated increase and decrease of the cell thickness may cause damage to the electrode and the electrolyte. In particular, when lithium metal is electroplated on the anode current collector 1D in a state where a fixed pressure is applied to the cell 1, the thickness of the cell increases. In this case, due to the thickness of the electroplated lithium metal, as shown in FIG. 2, a step or crack may occur between the anodes 1C and 1D and the electrolyte layer 1B at the edge part of the cell 1.

### SUMMARY

Accordingly, the present disclosure has been created to solve the above problems. Thus, an objective of the present disclosure is to provide a dynamic pressurizing system capable of varying and adjusting the pressurizing pressure for an all-solid-state battery in real-time.

In particular, another objective of the present disclosure is to provide an active pressurizing system capable of maintaining pressure always within a suitable pressure range in an all-solid-state battery regardless of a charging/discharging state. Furthermore, the active pressurizing system is capable of applying an optimal pressurizing pressure suitable for a charging/discharging state to the all-solid-state battery.

The objective of the present disclosure is not limited to the objective mentioned herein, and other objectives not mentioned are clearly understood by those having ordinary skill in the art (hereinafter referred to as “person of ordinary skill”) from the description below.

According to an embodiment of the present disclosure, a pressurizing system for an all-solid-state battery includes: a pressurizing mechanism provided to pressurize an all-solid-state battery and driven to adjust and change the pressure applied to the all-solid-state battery. The pressurizing system for an-solid-state battery further includes a driving device operated to drive the pressurizing mechanism, and a controller. The controller is configured to control the operation of the driving device so that the pressure to pressurize the all-solid-state battery can be adjusted and varied by the pressurizing mechanism.

When the all-solid-state battery is charged or discharged, the controller may control the operation of the driving device based on the pressure change rate so that the pressure pressurizing the all-solid-state battery may be adjusted and varied according to the pressure change rate determined based on the state information of the all-solid-state battery.

The pressurizing mechanism may include a fixed plate fixedly positioned, and a movable plate provided to pressurize the all-solid-state battery disposed between the two fixed plates and moved by the driving device to adjust and vary the pressure The pressurizing applied to the all-solid-state battery. mechanism may further include a guide unit for guiding the movement of the movable plate along guide rods.

In an embodiment of the present disclosure, the pressurizing mechanism includes two pressurizing plates for pressurizing the all-solid-state battery therebetween. The driving device includes a cylinder mechanism for controlling the forward and backward movement of the piston according to a control signal output from the controller. The cylinder mechanism may allow one of the two pressurizing plates moving the piston forward and backward when adjusting and changing the pressure applied to the all-solid-state battery.

In addition, the driving device may further include a fluid control device that controls the supply and discharge of fluid to the cylinder mechanism in order to control the forward and backward movement of the piston.

The fluid control device may include: a fluid supply line connected to a main cylinder body in which a piston is installed in the cylinder mechanism; a fluid discharge line connected to the main cylinder body for fluid discharging; and a first delivery device installed in the fluid supply line to supply fluid to the main cylinder body and controlled by the controller. The fluid control device may further include a first valve installed in the fluid supply line and controlled for opening and closing operation by the controller; and a second valve installed in the fluid discharge line and controlled for opening and closing operation by the controller.

In addition, the fluid control device may further include a second delivery device installed in the fluid discharge line to suck and discharge a fluid from a main cylinder body and controlled to be driven by the controller.

In addition, the fluid control device further includes a pressure gauge installed in the fluid supply line or the main cylinder body to detect a pressure state of the fluid supplied into the main cylinder body. The controller may control the fluid control device so that the fluid pressure in the main cylinder body is increased or decreased according to the predetermined pressure change rate based on the pressure state information detected by the pressure gauge.

In addition, the controller may control the operation of the driving device to increase the pressure to pressurize the all-solid-state battery when charging the all-solid-state battery. The controller may also control the operation of the driving device to reduce the pressure to pressurize the all-solid-state battery when discharging the all-solid-state battery.

In addition, the controller may control the operation of the driving device to reduce the pressure of pressurizing the all-solid-state battery when charging the all-solid-state battery. The controller may control the operation of the driving device to increase the pressure of pressurizing the all-solid-state battery when discharging the all-solid-state battery.

Accordingly, according to the pressurizing system for an all-solid-state battery according to the present disclosure, the pressure applied to the all-solid-state battery may be varied in real-time according to the charging and discharging state of the all-solid-state battery. Thus varying the pressure always maintaining the pressure in the all-solid-state battery within a suitable range regardless of the charging and discharging state.

In particular, the all-solid-state battery may be subjected to optimal pressure according to the charging and discharging state, and the conventional structural deterioration problem caused by repeated expansion and contraction of the cell can be solved.

In addition, it is possible to effectively prevent damage to electrodes and electrolytes due to repeated charging and discharging of all-solid-state batteries, repeated expansion, and contraction of cell volume, repeated increase and decrease of cell thickness, and an internal short circuit and an overcharge phenomenon caused by the short circuit may be prevented. Additionally, an all-solid-state battery with stable capacity may be expressed.

### BRIEF DESCRIPTION OF THE DRAWINGS

In order for the disclosure to be well understood,

various forms thereof are described below, given by way of example, reference being made to the accompanying drawings, in which:

FIG. 1 is a diagram explaining a charging and discharging process of a general lithium-free all-solid-state battery;

FIG. 2 is a diagram explaining problems with a conventional lithium-free all-solid-state battery;

FIG. 3 is a configuration diagram showing a pressurizing system of an all-solid-state battery according to an embodiment of the present disclosure;

FIG. 4 is a block diagram showing a main configuration of a pressurizing system according to an embodiment of the present disclosure;

FIGS. 5A and 5B are diagrams showing an operating state of a pressurizing system according to an embodiment of the present disclosure;

FIG. 6 is a diagram showing charging and discharging voltage states according to capacities of an all-solid-state battery to which a pressurizing system according to the present disclosure is applied;

FIGS. 7 and 8 are diagrams showing pressure states during charging and discharging controlled by the pressurizing system according to the present disclosure; and

FIG. 9 is a schematic view showing a pressure control method performed whenever charging and discharging are repeated in the present disclosure.

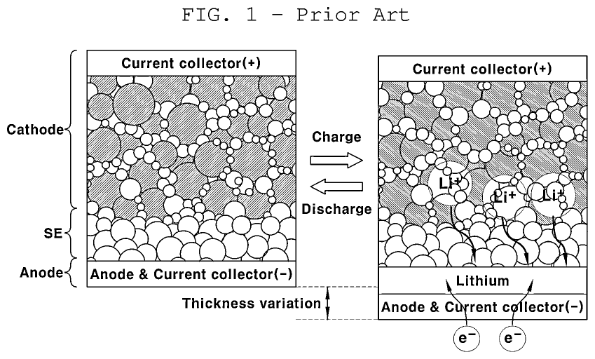

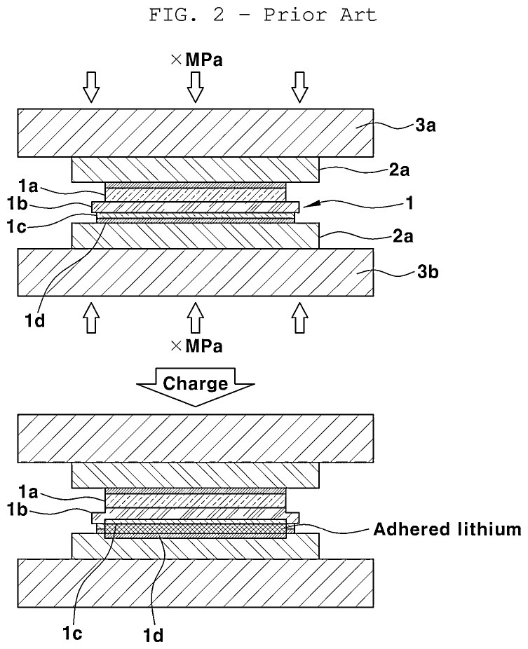

### DETAILED DESCRIPTION

Hereinafter, embodiments according to the present

disclosure are described in detail with reference to the accompanying drawings. The specific structural or functional descriptions presented in the embodiments of the present disclosure are only exemplified for the purpose of describing the embodiments according to the concept of the present disclosure. Furthermore, the embodiments according to the concept of the present disclosure may be implemented in various forms. In addition, the present disclosure should not be construed as being limited to the embodiments described herein. The present disclosure should be understood to include all modifications, equivalents, and substitutes included in the spirit and scope of the present inventive concept.

In the present disclosure, terms such as “first” and/or “second” can be used to describe various components, but the components are not limited by the terms. The above terms are used only for the purpose of distinguishing one element from other elements. For example, within the scope of not departing from the scope of the rights according to the concept of the present disclosure, the first element may be named as the second element. Similarly, the second component may also be referred to as a first component.

It should be understood that when any element is referred to as being “connected” or “coupled” to another element, one element may be directly connected or coupled to the other element, or an intervening element may be present therebetween. On the other hand, when an element is referred to as “directly connected” or “directly in contact with” another element, it should be understood that no other element exists in the middle. Other expressions used to describe the relationship between components, such as “between” and “directly between” or “adjacent to” and “directly adjacent to” should be interpreted similarly.

Like reference numbers refer to like elements throughout. The terminology used herein is for describing the embodiments and is not intended to limit the present disclosure. In this specification the singular form also includes the plural form unless otherwise specified in the phrase. As used in the specification, “comprises” and/or “comprising” do not preclude the presence or addition of one or more other elements, steps, operations, and/or devices mentioned in the device.

When a component, device, element, or the like of the

present disclosure is described as having a purpose or performing an operation, function, or the like, the component, device, or element should be considered herein as being “configured to” meet that purpose or to perform that operation or function.

The present disclosure relates to a dynamic pressurizing system capable of actively adjusting and varying the pressurizing pressure of an all-solid-state battery according to the charging and discharging states of the all-solid-state battery.

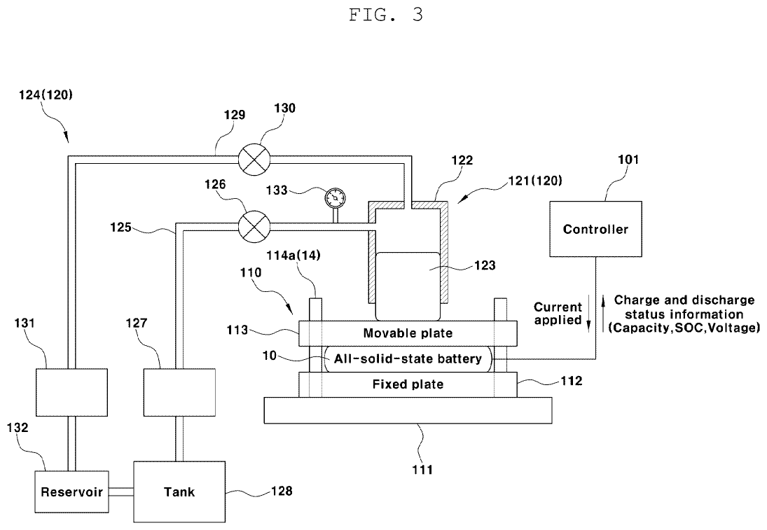

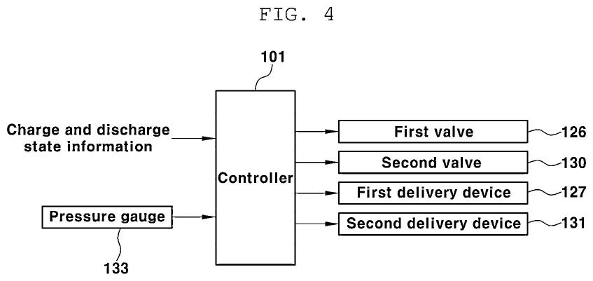

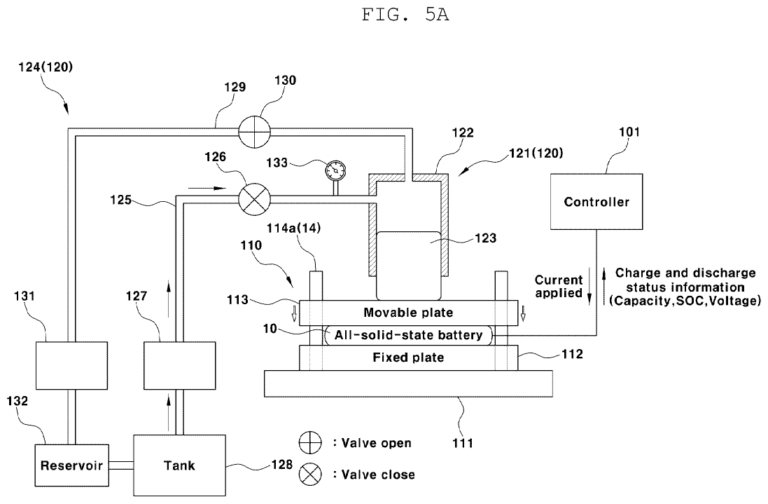

FIG. 3 is a configuration diagram showing a pressurizing system for an all-solid-state battery according to an embodiment of the present disclosure. FIG. 4 is a block diagram showing the main configuration of the pressurizing system according to an embodiment of the present disclosure. FIGS. 5A and 5B are diagrams showing an operating state of a pressurizing system according to an embodiment of the present disclosure.

The pressurizing system, according to the present disclosure, may be applied to a battery mounted on a vehicle. Specifically, the pressurizing system may be applied to a high voltage battery that supplies power for the operation of a motor (not shown) driving an electric vehicle.

A battery to which the pressurizing system, according to the present disclosure, is applied may be an all-solid-state battery. The all-solid-state battery may be a battery to which a lithium-free anode technology is applied, i.e., a lithium-free battery.

In addition, the all-solid-state battery to which the pressurizing system, according to the present disclosure, is applied is not shown in detail in the drawing. However, the all-solid-state battery may be discharged or charged by the motor by being connected via an inverter to the motor, which is the driving device of the vehicle.

In addition, the all-solid-state battery to which the pressurizing system is applied, according to the present disclosure, may be connected to an in-vehicle charging device, including a converter and the like. The all-solid-state battery may be charged by receiving power supplied from an external charger through the in-vehicle charging device. Alternatively, the all-solid-state battery to which the pressurizing system, according to the present disclosure, is applied may be charged by receiving power directly from a charger outside the vehicle.

As for the all-solid-state battery to which the pressurizing system according to the present disclosure is applied, there is no difference from known all-solid-state batteries in its configuration. Furthermore, the configuration of the all-solid-state battery is well known to those having ordinary skill in the art, and thus a detailed description thereof is omitted.

Referring to the configuration with reference to FIG. 3, the pressurizing system according to the present disclosure may include a pressurizing mechanism 110 provided to pressurize the all-solid-state battery at a controlled pressure. The pressurizing mechanism 110 may include two pressurizing plates 112 and 113 disposed on both sides with the all-solid-state battery 10 interposed therebetween.

A typical all-solid-state battery 10 has a structure in which a plurality of cells is stacked. In other words, a typical all-solid-state battery may include a cell stacked product in which a plurality of cells is stacked. In the present disclosure, the all-solid-state battery 10 that is pressurized by the two pressurizing plates 112 and 113 may have one cell but may include a cell stacked product in which a plurality of cells is stacked instead of one cell.

One of the two pressurizing plates 112 and 113 is positioned (e.g., placed) to be pressurized on the cathode side of the cell stacked on one end of the cell stacked product of the all-solid-state battery 10. The other plate of the two pressurizing plates 112 and 113 is positioned to be pressurized on the anode side of the cell stacked on the opposite end of the cell stacked product.

In an embodiment of the present disclosure, the pressurizing mechanism 110 may include a fixed plate 112 and a movable plate 113 disposed with the all-solid-state battery 10 interposed therebetween. Among the two pressurizing plates, one is a fixed plate 112 fixedly positioned, and the other is a movable plate 113 installed to be movable.

In FIG. 3, among the two pressurizing plates disposed with the all-solid-state battery 10 therebetween, the pressurizing plate 112 that is disposed on the lower side is a fixed plate fixed configured not to move. The pressurizing plate 113 disposed on the upper side is a movable plate that can move up and down.

In the embodiment of FIG. 3, two pressurizing plates 112 and 113 are disposed horizontally, a pedestal 111 is fixedly installed at the bottom, and a fixed plate 112 is fixedly installed on the pedestal 111. The pedestal 111 is a fixed structure.

Then, the all-solid-state battery 10 is arranged to be supported on the fixed plate 112, and as shown, the all-solid-state battery 10 may be positioned to be placed on the upper surface of the fixed plate 112.

The movable plate 113 is installed to be movable along the guide part 114 that is installed on the pedestal 111. The movable plate 113 may be provided to move along the guide part 114 while disposed above the all-solid-state battery 10 to pressurize the upper surface of the all-solid-state battery 10.

In the embodiment of FIG. 3, the movable plate 113 is coupled to the guide part 114 so as to be guided up and down. The guide part 114 may include a plurality of guide rods 114A installed to vertically extend on the pedestal 111.

As shown, the movable plate 113 is coupled to a plurality of guide rods 114A, and the guide rods 114A may be coupled to form a structure passing through the movable plate 113. Accordingly, the movable plate 113 may move up and down along the longitudinal direction of the guide rod 114A while maintaining a horizontal state.

The plurality of guide rods 114A may be disposed around the all-solid-state battery 10 and can be positioned at predetermined intervals along the edges of the two pressurizing plates, i.e., the fixed plate 112 and the pressurizing type plate 113.

For example, four guide rods 114A may be disposed to be positioned at square corner parts of the fixed plate 112 and the movable plate 113. This arrangement structure (e.g., guide unit) is illustrative, and the present disclosure is not limited thereby. Additionally, the number and location of guide rods may be variously changed from those illustrated.

In the embodiment of the present disclosure, both of the two pressurizing plates (fixed plate and movable plate) 112 and 113 may be metal plates, desirably anodized metal plates to form an oxide film.

Conventional all-solid-state batteries have terminals for electrical connection with the outside, but in FIG. 3, the terminals of the all-solid-state battery and electrical wires connected thereto are omitted.

On the other hand, the pressurizing system, according to the present disclosure, is configured to adjust and change the pressure applied to the all-solid-state battery 10 according to the state of the all-solid-state battery 10. In the following disclosure, the term “pressurization pressure” refers to a pressure applied by the pressurizing system to the all-solid-state battery 10, i.e., a pressure to pressurize the all-solid-state battery 10. Additionally, the term “pressurization pressure” refers to a pressure applied to the all-solid-state battery 10 by the pressurizing system.

In the present disclosure, the force or pressure that the pressurizing system pressurizes on the all-solid-state battery 10 is due to the fluid pressure in the driving device, as is described below. In the present disclosure, in order to control the pressurized pressure of the all-solid-state battery 10, the fluid pressure of the driving device described below is controlled.

The pressurizing system, according to an embodiment of the present disclosure, may be configured to further include the driving device 120 that is driving the pressurizing mechanism 110 to apply controlled pressure to the all-solid-state battery 10. Furthermore, the pressurizing system may be configured to include a controller 101 that controls the operation of the driving device 120 so that the pressure applied to the all-solid-state battery 10 can be adjusted and varied by the pressurizing mechanism 110.

In an embodiment of the present disclosure, the controller 101 controls the operation of the driving device 120 based on the pressure change rate so that the pressure applied to the all-solid-state battery 10 may be adjusted and varied during charging or discharging of the all-solid-state battery 10.

The driving device 120 is controlled to drive the pressurizing mechanism 110 according to the control signal of the controller 101. In particular, by driving the pressurizing mechanism 110 according to the control signal output by the controller 101, the pressure applied to the all-solid-state battery 10 can be adjusted and changed to the desired level.

In other words, the operation of the driving device 120 is controlled according to the control signal output by the controller 101, and the pressurizing mechanism 110 is driven by the operation of the driving device 120 so that the pressure applied by the pressurizing mechanism (pressurizing pressure for the all-solid-state battery 10) can be varied.

In the present disclosure, the controller 101 determines the pressure change rate based on the state information of the all-solid-state battery 10 as described herein. The state information of the all-solid-state battery 10 for determining the pressure change rate includes a charge capacity of a previous charging process (a charging process of the previous charge/discharge cycle) and a discharge capacity of a previous discharging process (a discharging process of the previous charge/discharge cycle). A method of determining the pressure change rate using the charge capacity of the previous charging process and the discharge capacity of the previous discharging process is described in detail below.

In an embodiment of the present disclosure, the driving device 120 may be configured to move the movable plate 113 of the pressurizing mechanism 110 along the guide part 114 during operation. The operation of the driving device 120 can be configured to control the position of the movable plate 113 in the pressurizing mechanism 110. Eventually, the pressure applied to the all-solid-state battery can be controlled by the movable plate 113 whose position is controlled.

In an embodiment of the present disclosure, the driving device 120 includes a cylinder mechanism 121 having a piston 123 that moves forward and backward depending on the supply and discharge state of the fluid. The driving device 120 further includes a fluid control device 124 that controls the supply and discharge of the fluid to the cylinder mechanism 121.

The cylinder mechanism 121 includes a main cylinder body 122 in which fluid is supplied and discharged. The cylinder mechanism 121 also includes a piston 123 that is provided to operate forward and backward according to the supply and discharge state of the fluid in the main cylinder body 122. The piston 123 drives the pressurizing mechanism 110 by moving forward and backward.

The main cylinder body 122 of the cylinder mechanism 121 is installed with a fixed position so as not to move. The main cylinder body 122 may be mounted on a separate fixed structure in which the position is fixed. In FIG. 3, the illustration of the fixed structure in which the main cylinder body 122 is fixed so as not to move is omitted.

The piston 123 when moving forward, is provided to push the movable plate 113 of the pressurizing mechanism 110 in the direction of pressurizing the all-solid-state battery 10 (i.e., compress the all-solid-state battery 10) . The forward and backward state of the piston 123 is controlled by supplying and discharging fluid to the main cylinder body 122 of the cylinder mechanism 121.

The fluid control device 124 includes a fluid supply line 125 and a fluid discharge line 129 connected to the cylinder mechanism 121. The fluid supply line 125 and the fluid discharge line 129 are connected to the main cylinder body 122 of the cylinder mechanism 121 to supply and discharge fluid.

In addition, the fluid supply line 125 and the fluid discharge line 129 are provided with a first valve 126 and a second valve 130 for opening and closing the flow path of the corresponding line, respectively. The first valve 126 and the second valve 130 are electronic valves whose opening and closing operations are controlled according to a control signal output from the controller 101.

When supplying the fluid into the main cylinder body 122 of the cylinder mechanism 121, the first valve 126 that is installed in the fluid supply line 125 is controlled to open according to the control signal output from the controller 101. Furthermore, when supplying the fluid into the main cylinder body 122 of the cylinder mechanism 121, the second valve 130 that is installed in the fluid discharge line 129 is controlled to close according to the control signal output from the controller 101.

On the other hand, when discharging the fluid from the cylinder mechanism 121, the first valve 126 installed in the fluid supply line 125 is controlled to close according to the control signal output by the controller 101. Additionally, when discharging the fluid from the cylinder mechanism 121, the second valve 130 installed in the fluid discharge line 129 is controlled to open according to the control signal output by the controller 101.

When fluid is supplied into the main cylinder body 122 of the cylinder mechanism 121, the piston 123 moves forward in a direction that pushes the movable plate 113 of the pressurizing mechanism 110. Thus, the pressure applied to the all-solid-state battery 10 is increased by the movable plate 113.

Conversely, when the fluid is discharged from the main cylinder body 122 of the cylinder mechanism 121, the piston 123 pushing the movable plate 113 can move backward (e.g., decompress the all-solid-state battery 10). Thus, the pressure applied to the all-solid-state battery 10 by the movable plate 113 may be reduced.

The fluid control device 124 may further include a pressure gauge 133 installed in the main cylinder body 122 of the fluid supply line 125 or the cylinder mechanism 121. The pressure gauge 133 is configured to detect the pressure state of the fluid supplied into the main cylinder body 122.

The pressure gauge 133 is provided in a state connected to the controller so that a pressure detection signal, which is an output signal, can be input to the controller 101. Additionally, the controller 101 can obtain pressure state information of the fluid in the main cylinder body 122 from the output signal of the pressure gauge 133.

Accordingly, the controller 101 outputs a control signal for controlling the operation of the fluid control device 124 of the driving device 120 based on the real-time pressure state information detected and acquired by the pressure gauge 133. Thus, the operation of the fluid control device 124 and the supply and discharge state of the fluid to the cylinder mechanism 121 is controlled according to the control signal output from the controller 101.

In addition, the fluid control device 124 may further include a first storage unit 128 in which fluid is stored. Furthermore, the fluid control device 124 may include a first delivery device 127 that supplies the fluid stored in the first storage unit 128 to the cylinder mechanism 121 through the fluid supply line 125.

The fluid supply line 125 is connected to the first storage unit 128 so that when the first delivery device 127 is driven, the fluid stored in the first storage unit 128 may be supplied to the cylinder mechanism 121 along the fluid supply line 125. The first storage unit 128 may be a tank or reservoir in which fluid may be stored, and the first delivery device 127 may be a pump whose driving is controlled according to a control signal from the controller 101.

In addition, the fluid control device 124 may further include a second storage unit 132 in which fluid discharged from the main cylinder body 122 of the cylinder mechanism 121 along the fluid discharge line 129 is stored.

The fluid discharge line 129 is connected to the second

storage unit 132, and a second delivery device 131 may be further installed in the fluid discharge line 129. The second storage unit 132 may also be a tank or reservoir in which fluid may be stored. The second delivery device 131 may be a pump whose driving is controlled according to a control signal from the controller 101.

The second delivery device 131 sucks fluid through the fluid discharge line 129 during operation, and through this, the fluid in the main cylinder body 122 of the cylinder mechanism 121 is discharged to the fluid discharge line 129.

The fluid sucked in by the second delivery device 131 and discharged from the main cylinder body 122 of the cylinder mechanism 121 is moved along the fluid discharge line 129 and then stored in the second storage unit 132.

In the present disclosure, the controller 101 outputs a control signal for variably adjusting the pressure applied to the all-solid-state battery 10 according to the charge and discharge state of the all-solid-state battery 10. Thus, the controller 101 controls the operation of the driving device 120 for pressure control.

Specifically, the controller 101 controls the operation of the fluid control device 124 so that the fluid pressure in the main cylinder body 122 of the cylinder mechanism 121 is increased or decreased at a predetermined pressure change rate. The controller 101 may control the operation of the driving device 120 so that the real-time pressure obtained from the output signal of the pressure gauge 133 increases or decreases at a predetermined pressure change rate.

The operation of the driving device 120 is controlled according to the control signal output by the controller 101, so that the fluid pressure in the driving device 120 can be controlled. As the fluid pressure is controlled, the pressure applied to the all-solid-state battery 10 may be controlled through the pressurizing mechanism 110.

Here, controlling the operation of the driving device 120 means controlling the operation of the fluid control device 124 of the driving device 120. The fluid pressure in the driving device 120 means the fluid pressure in the main cylinder body 122 of the cylinder mechanism 121.

In controlling the fluid pressure in the main cylinder body 122 of the cylinder mechanism 121, the controller 101 obtains real-time pressure state information from the signal of the pressure gauge 133. The controller 101 then outputs a control signal according to the obtained real-time pressure state to control the operation of the fluid control device 124 including the first valve 126 and the first delivery device 127.

The controller 101 outputs a control signal to increase or decrease the fluid pressure in the main cylinder body 122 of the cylinder mechanism 121 at a prescribed pressure change rate using the pressure state information detected by the pressure gauge 133. Therefore, as the operation of the fluid control device 124 is controlled according to the control signal, the fluid pressure in the driving device 120, i.e., the fluid pressure in the main cylinder body 122, may be increased or decreased.

FIG. 5A shows a control state of the pressurizing system increasing the pressure applied to the all-solid-state battery 10. When the all-solid-state battery 10 is discharging, the fluid pressure in the main cylinder body 122 of the cylinder mechanism 121 is gradually increased according to a predetermined pressure change rate.

The controller 101 outputs a control signal for increasing the fluid pressure (i.e., a control signal for increasing the pressurized pressure). This control signal controls the operation of the fluid control device 124 so that the fluid stored in the first storage unit 128 can be supplied to the main cylinder body 122 of the cylinder mechanism 121 through the fluid supply line 125.

The controller 101 outputs a control signal for increasing the pressurized pressure applied to the all-solid-state battery 10 based on the real-time pressure state information obtained from the signal of the pressure gauge 133. First, the first valve 126 is opened by a control signal output from the controller 101.

In addition, the first delivery device 127 is driven by the control signal to supply the fluid stored in the first storage unit 128 to the main cylinder body 122 along the fluid supply line 125. While increasing the pressure applied to the all-solid-state battery 10, the second valve 130 is maintained in a closed state, and the operation of the second delivery device 131 is stopped.

Eventually, as fluid is supplied from the cylinder mechanism 121 of the driving device 120 to the inside of the main cylinder body 122, the piston 123 moves forward. Since the piston 123 pushes the movable plate 113, the movable plate 113 is finely moved to pressurize the all-solid-state battery 10.

As a result, the surface pressure applied to the all-solid-state battery 10 through the movable plate 113 can be gradually increased at the predetermined pressure change rate. Then, referring to the output signal of the pressure gauge 133, the controller 101 stops the pressure control when it is determined that the pressure has reached a predetermined pressure. The controller 101 stops the operation of the first delivery device 127 and closes the first valve 126 again.

Alternatively, the pressure control may be terminated when the cell discharge of the all-solid-state battery 10 is terminated. In this case, the cell discharge termination criterion is a preset lower limit voltage. In other words, when the voltage of the all-solid-state battery 10 reaches the lower limit voltage while the cell is being discharged, the controller 101 outputs a signal to close the first valve 126 and stop driving the first delivery device 127.

FIG. 5B shows a control state of the pressurizing system for decreasing the pressure applied to the all-solid-state battery 10. When the all-solid-state battery 10 is charging, the fluid pressure in the main cylinder body 122 of the cylinder mechanism 121 is gradually reduced according to a predetermined pressure change rate.

The controller 101 outputs a control signal for reducing the fluid pressure (i.e., a control signal for reducing the pressurized pressure). This control signal controls the operation of the fluid control device 124 so that the fluid in the main cylinder body 122 of the cylinder mechanism 121 may be discharged through the fluid discharge line 129.

The controller 101 outputs a control signal for reducing the pressure applied to the all-solid-state battery 10 based on the real-time pressure state information obtained from the signal of the pressure gauge 133. The second valve 130 is opened so that the fluid in the main cylinder body 122 is discharged to the fluid discharge line 129, and the first valve 126 is kept closed.

The second valve 130 is opened to reduce the pressurized pressure that pressurizes the all-solid-state battery 10 so that the fluid required for pressure control is discharged from the inside of the main cylinder body 122 to the outside through the fluid discharge line 129. The controller 101 may drive the second delivery device 131 since fluid discharging may be difficult to discharge a desired flow rate of fluid only by opening the second valve 130.

In other words, the second delivery device 131 is driven by the control signal output by the controller 101 to suck the fluid through the fluid discharge line 129. Thus, the controller 101 is configured to discharge the required flow rate of the fluid for pressure control from the main cylinder body 122.

The controller 101 outputs a control signal to reduce the pressure in the main cylinder body 122 according to the predetermined pressure change rate. The predetermined pressure change rate is based on real-time pressure information obtained from the pressure gauge 133 that is used to reduce the pressurizing pressure of the all-solid-state battery 10. The control signal drives the second delivery device 131 to discharge fluid from the main cylinder body 122. The first valve 126 is kept closed, and the first delivery device 127 is not operated.

As a result, the surface pressure applied to the all-solid-state battery 10 through the movable plate 113 can be gradually reduced at the predetermined pressure change rate. Then, referring to the output signal of the pressure gauge 133, the controller 101 stops the pressure control when it is determined that the pressure has reached a predetermined pressure, and the controller 101 stops the operation of the second delivery device 131, closing the second valve 130 again.

Alternatively, the pressure control may be terminated at the same time that the cell charging of the all-solid-state battery 10 is terminated. In this case, the cell charging termination criterion is a preset upper limit voltage. In other words, when the voltage of the all-solid-state battery 10 reaches the upper limit voltage while the cell is being charged, the controller 101 outputs a signal to close the second valve 130 and stop driving the second delivery device 131.

As described herein, the pressure applied to the all-solid-state battery 10 is increased when the all-solid-state battery 10 is discharged. Furthermore, the pressure applied to the all-solid-state battery 10 is decreased when the all-solid-state battery 10 is charged. Alternatively, it could also be the other way around.

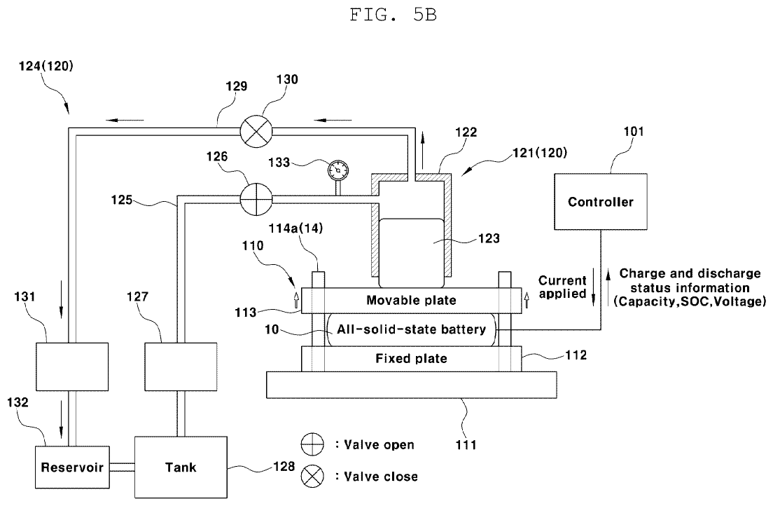

FIG. 6 is a diagram showing charging and discharging voltage states according to capacities of an all-solid-state battery 10 to which a pressurizing system is applied, according to the present disclosure. As shown therein, the voltage of the all-solid-state battery 10 may increase as the all-solid-state battery 10 is charged, and the voltage may decrease as the all-solid-state battery 10 is discharged.

In addition, according to the data in FIG. 6, the charge capacity after charging the all-solid-state battery 10 and the discharge capacity after discharging the all-solid-state battery 10 can be known.

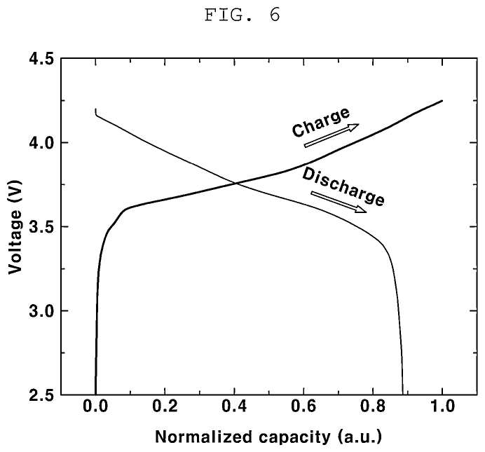

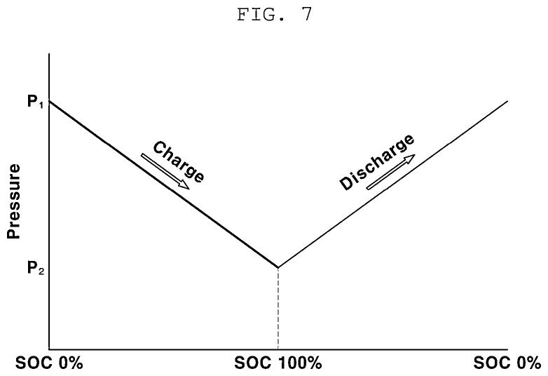

FIGS. 7 and 8 are diagrams showing pressure states during

charging and discharging controlled by the pressurizing system according to the present disclosure.

First, as shown in FIG. 7, the pressure applied to the all-solid-state battery 10 by the pressurizing mechanism 110 during charging can be gradually reduced at a predetermined pressure change rate (ΔP<0, where ΔP is the pressure change rate) . Furthermore, the pressure applied to the all-solid-state battery 10 may be gradually increased at a predetermined pressure change rate during discharging (ΔP>0). This is as described with reference to FIGS. 5A and 5B.

The pressure applied to the all-solid-state battery 10 by the pressurizing mechanism 110 can be controlled by controlling the fluid pressure in the main cylinder body 122 of the cylinder mechanism 121 based on the pressure detected by the pressure gauge 133.

On the contrary, as shown in FIG. 8, the pressure applied to the all-solid-state battery 10 by the pressurizing mechanism 110 during charging may be gradually increased at a predetermined pressure change rate (ΔP<0). The pressure applied to the all-solid-state battery 10 by the pressurizing mechanism 110 during discharging may be gradually reduced at a predetermined pressure change rate (ΔP<0).

The pressure applied to the all-solid-state battery 10 by the pressurizing mechanism 110 can be controlled by controlling the fluid pressure in the main cylinder body 122 of the cylinder mechanism 121 based on the pressure detected by the pressure gauge 133.

On the other hand, in increasing or decreasing the pressure applied to the all-solid-state battery 10 using the pressurizing system, a predetermined pressure change rate may be obtained from a charge capacity of a previous charging process (a charging process of a direct charge/discharge cycle) or a discharge capacity of a previous discharging process (a discharging process of a direct charge/discharge cycle).

Describing the method for determining the charge capacity and discharge capacity, the state of charge (SOC) of the all-solid-state battery 10 means the degree of charge (state of charge) of the battery. For example the SOC 0 is a 0% charged state, and the SOC 100 means a 100% charged state.

The standard of SOC 100 is to calculate the capacity expressed when a corresponding battery is charged up to a specific upper limit voltage such as 100%. For example, if charging to 2.5 to 4.3V is assumed, a capacity (e.g., 200 mAh/g) corresponding to the battery when charging reaches 4.3V is equal to 100% SOC. However, since the value of capacity expressed in each charge and discharge process is different, the capacity corresponding to 100% of SOC in each cycle is also different.

A capacity corresponding to 100% SOC is different for each charging process and discharging process. A pressure change rate may be determined using the last capacity value of the previous charging and discharging process unless an internal short circuit occurs.

In the present disclosure, the charge capacity may be determined based on a capacity value when the voltage of the all-solid-state battery 10 reaches a predetermined upper limit voltage. The discharge capacity may be determined based on a capacity value when the voltage of the all-solid-state battery 10 reaches a predetermined lower limit voltage.

When an all-solid-state battery 10 is charged, a positive (+) current is applied to a cell, and in this case, a voltage of the all-solid-state battery 10 gradually increases to reach a predetermined upper limit voltage. Additionally, a value obtained by multiplying a time h until reaching an upper limit voltage during charging by the current (A or mA) applied in a charging step becomes a charging capacity (Ah or mAh). Similarly, during discharging, the voltage of the all-solid-state battery gradually decreases to reach a preset lower limit voltage, and the discharge capacity may be calculated by multiplying the time and current at this time.

In a lithium-free all-solid-state battery, the charge capacity is directly related to how much lithium (Li) is deposited on the anode (i.e., how much lithium is electroplated). The discharge capacity is directly related to how much lithium is desorbed from the anode.

For example, if the charging capacity was 100 mAh/g, lithium (Li) would have accumulated by 100. If the charging capacity was 80 mAh/g due to a decrease in battery life during the subsequent charging process, it could be said that lithium also accumulated by 80.

The amount of accumulated lithium m (electroplating amount) is important because the degree of volume expansion of the cell and the pressure in the cell varies depending on the amount of accumulated lithium. The more lithium is accumulated (the higher the charging capacity), the higher the volume expansion rate and thickness increase rate of the cell will be. If a conventional fixed pressurizing device is applied, the pressure applied to the cell will increase as the cell expands and the thickness increases.

Likewise, the discharge capacity is also important, and the discharge process is a process where lithium (Li) accumulated in the anode is desorbed during the charging process. The cell volume is contracted during the discharging process. The greater the amount of lithium desorbed (discharge capacity), the greater the volumetric shrinkage rate and thickness reduction rate of the cell. If a fixed pressurizing device is applied, the pressure applied to the cell will also decrease as the cell shrinks and the thickness decreases.

In short, the charge capacity and discharge capacity are indicators that can indirectly check the amount of electroplating and desorption of lithium. Since a volume change of the cell appears, a pressure change rate in the current charging or discharging process should be determined based on the charge capacity in the previous charging process and the discharge capacity in the previous discharging process.

Hereinafter, a method for formulaically determining a pressure change rate during charging and discharging is described.

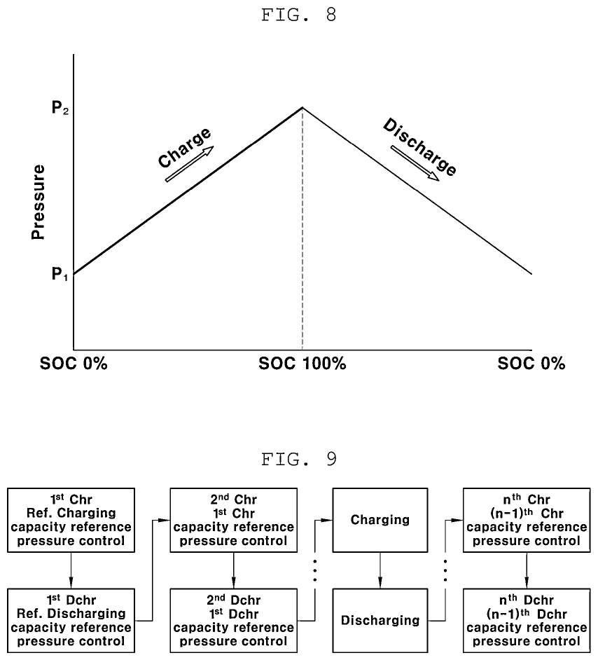

FIG. 9 is a diagram schematically showing a pressure control method performed whenever charging and discharging processes are repeated in the present disclosure. FIG. 9 also shows a pressure control method when a charging process and a discharging process are alternately repeated.

Referring to FIG. 9, it can be seen that during the first charging process and the first discharging process, which is the first cycle, pressure control is performed based on the preset charging capacity of the reference. The pressure control is implemented based on the charge capacity and discharge capacity of the immediately preceding process from the second process.

As described herein, the pressure change rate (ΔP) for controlling the pressure applied to the all-solid-state battery 10 at each charging and discharging process may be determined using the capacity information of the previous process. The pressure change rate (ΔP) becomes the slope of the pressure change applied to the all-solid-state battery 10 in the examples of FIGS. 7 and 8.

In the example of FIG. 7, the pressure change rate (ΔP) in the charging process is a negative value (ΔP<0), and the pressure change rate (ΔP) in the discharging process is a positive value (ΔP>0). In other words, during the charging process, the pressure applied to the all-solid-state battery 10 is reduced according to the pressure change rate determined based on the charging capacity of the previous process. Furthermore, during the discharging process, the pressure applied to the all-solid-state battery 10 is increased according to the pressure change rate determined based on the charging capacity of the previous process.

Conversely, in the example of FIG. 8, the pressure change rate (ΔP) in the charging process is a positive (+) value (ΔP>0), and the pressure change rate (ΔP) in the discharging process is a negative (−) value (ΔP<0). In other words, during the charging process, the pressure applied to the all-solid-state battery 10 is increased according to the pressure change rate determined based on the charge capacity of the previous process. Furthermore, during the discharging process, the pressure applied to the all-solid-state battery 10 is reduced according to the pressure change rate determined based on the charging capacity of the previous process.

For example, it is possible to determine the pressure change rate (ΔP₂^{Chr}) for controlling the pressure applied to the all-solid-state battery 10 during the second cycle charging process (“2nd Chr” in FIG. 9) using the charge capacity (Q₁^{Chr}) in the charging process of the first cycle (“1st Chr” in FIG. 9) (“1st Chr capacity reference pressure control” in FIG. 9).

In addition, it is possible to determine the pressure change rate (ΔP₂^{Dchr}) for controlling the pressure applied to the all-solid-state battery 10 during the discharging process of the second cycle (“2nd Dchr” in FIG. 9) using the discharge capacity (Q₁^{Dchr}) in the discharge process of the first cycle (“1st Dchr” in FIG. 9) (“1st Dchr capacity reference pressure control” in FIG. 9) .

In this specification, the charging process and the discharging process may be defined as one cycle. In the following description, the nth charging process and the nth discharging process mean the charging process and the discharging process of the nth cycle, respectively.

Generally, it is possible to determine the pressure change rate (ΔPₙ^{Chr}) for controlling the pressure applied to the all-solid-state battery 10 during the nth charging process (“nth Chr” in FIG. 9) using the charging capacity in the ((n−1)th charging process (“(n−1)th Chr capacity” in FIG. 9, Qₙ₋₁^{Chr}) (“ (n−1)th Chr capacity reference pressure control” in FIG. 9).

Similarly, it is possible to determine the pressure change rate (ΔPₙ^{Dchr}) for controlling the pressure applied to the all-solid-state battery 10 during the nth discharging process (“nth Dchr” in FIG. 9) using the discharge capacity in the (n−1)th discharging process (“(n−1)th Dchr capacity” in FIG. 9, Qₙ₋₁^{Dchr}) (“(n−1)th Dchr capacity reference pressure control” in FIG. 9).

However, for the pressure change rate (ΔP₁^{Chr}) in the first charging process (“1st Chr”), a value according to a preset reference charging capacity is used (“Ref. Charging capacity reference pressure control” in FIG. 9). As the pressure change rate (ΔP₁^{Dchr}) in the first discharge process (“1st Dchr”), a value according to a preset reference discharge capacity may be used (“Ref. Discharge capacity reference pressure control” in FIG. 9).

The Formula for determining the pressure change rate is summarized and expressed as follows.

In the present disclosure, the pressure change rate is defined as the rate at which the pressure changes with respect to the state of charge of the all-solid-state battery 10 during the charging or discharging of the all-solid-state battery 10, i.e., the SOC value. In other words, as shown in FIGS. 7 and 8, when the SOC value changes in the range of 0% to 100%, the pressure change rate in the present disclosure is the rate at which the pressure changes with respect to the SOC 0% to 100%, which is the slope of each graph shown in FIGS. 7 and 8.

In the present disclosure, the pressure applied to the all-solid-state battery 10 is adjusted to vary linearly as the real-time SOC value changes during charging or discharging of the all-solid-state battery 10. In other words, the pressure applied to the all-solid-state battery 10 is linearly varied according to the pressure change rate (slope) with respect to the change in the SOC value of the all-solid-state battery 10 during charging or discharging.

To explain the pressure change rate in more detail, for example, when the charge capacity is 200 mAh/g, and the value of the corresponding capacity is 100% SOC, 100 mAh/g becomes 50% SOC. In other words, SOC means remaining capacity after all. In the present disclosure, since the applied current may be different depending on the cell and the capacity may be changed based on the same time, the pressure change rate may be defined as the change rate for the capacity. In other words, the [MPa/(mAh/g)] unit described in “Case 1” and “Case 2” below represents the unit of the pressure change rate.

First, “Case 1” below shows an example of reducing the pressure applied to the all-solid-state battery 10 during charging and increasing the pressure applied to the all-solid-state battery 10 during discharging, as shown in the example of FIG. 7. In “Case 1”, the pressurizing system can be set to vary the pressure in the range of 1 to 3 MPa.

$$Case 1.$$

$$Δ {P}_{1}^{Chr} = - \frac{2 MPa}{200 mAh / g} = - 0.01 \frac{MPa}{mAh / g} \\ Δ {P}_{1}^{Dchr} = + \frac{2 MPa}{180 mAh / g} = + 0.011 \frac{MPa}{mAh / g} \\ Δ {P}_{2}^{Chr} = - \frac{2 MPa}{{Q}_{1}^{Chr} mAh / g} Δ {P}_{2}^{Dchr} = + \frac{2 MPa}{{Q}_{1}^{Dchr} mAh / g} \\ ⋮ \\ Δ {P}_{n}^{Chr} = - \frac{2 MPa}{{Q}_{n - 1}^{Chr} mAh / g} Δ {P}_{n}^{Dchr} = + \frac{2 MPa}{{Q}_{n - 1}^{Dchr} mAh / g}$$

In “Case 1” above, the pressure change rate (ΔPₙ^{Chr}) of the charging process shows a negative (−) value, and the pressure change rate (ΔPₙ^{Dchr}) of the discharging process shows a positive (+) value.

“Case 2” below shows an example of increasing the pressure applied to the all-solid-state battery 10 during charging and reducing the pressure applied to the all-solid-state battery 10 during discharging, as shown in the example of FIG. 8. In “Case 2,” the pressurizing system can be set to vary the pressure in the range of 1 to 3 MPa.

$$Case 2.$$

$$Δ {P}_{1}^{Chr} = - \frac{2 MPa}{200 mAh / g} = + 0.01 \frac{MPa}{mAh / g} \\ Δ {P}_{1}^{Dchr} = + \frac{2 MPa}{180 mAh / g} = - 0.011 \frac{MPa}{mAh / g} \\ Δ {P}_{2}^{Chr} = + \frac{2 MPa}{{Q}_{1}^{Chr} mAh / g} Δ {P}_{2}^{Dchr} = - \frac{2 MPa}{{Q}_{1}^{Dchr} mAh / g} \\ ⋮ \\ Δ {P}_{n}^{Chr} = + \frac{2 MPa}{{Q}_{n - 1}^{Chr} mAh / g} Δ {P}_{n}^{Dchr} = - \frac{2 MPa}{{Q}_{n - 1}^{Dchr} mAh / g}$$

In “Case 2” above, the pressure change rate (ΔPₙ^{Chr}) of the charging process shows a negative (+) value, and the pressure change rate (ΔPₙ^{Dchr}) of the discharging process shows a positive (−) value.

For reference, in the Formulae of “Case 1” and “Case 2, ” the number “2” of the molecule represents the difference between the highest pressure and the lowest pressure in the variable and the controllable pressure range (1 to 3 MPa) by the pressurizing system.

According to the Formulae of “Case 1” and “Case 2,” the control range of the pressurized pressure for the all-solid-state battery 10 may be preset in the controller 101. The controller 101 may determine a pressure change rate by dividing a difference value between a maximum pressure and a minimum pressure in the set range by a charge and discharge capacity of the previous process.

In addition, the subscript below represents the cycle number of the corresponding charging process or discharging process, where the subscript “1” represents the process of the first cycle, and the subscript “2” represents the process of the second cycle.

In addition, the subscripts “n−1” and “n” indicate the process of the (n−1)th cycle and the process of the nth cycle, respectively, which are abbreviated as (n−1)th process and nth process in this specification. Furthermore, the superscript “Chr” indicates charge, the superscript “Dchr” indicates discharge, “ΔP” indicates pressure change rate, and “Q” indicates capacity.

Specifically, “ΔPₙ” represents the pressure change rate

of the process of the nth cycle, “ΔPₙ^{Chr}” represents the pressure change rate of the nth charging process, and “ΔPₙ^{Chr}” represents the pressure change rate of the nth discharging process. In addition, “Qₙ₋₁^{Chr}” represents the charge capacity of the (n−1)th charge process, which is the previous process, and “Qₙ₋₁^{DChr}” represents the discharge capacity of the (n−1)th discharge process, which is the previous process.

In general, “ΔP” means a change in the amount of pressure, and it is common to indicate the change in the amount of pressure as “ΔP.” However, in this specification, the pressure change rate is expressed as “ΔP,” and in the above Formula, a time term h exists in the unit of “ΔP.”

When a current is applied during charging, a fixed current value having a unit of mA/g or mA/cm² is applied, and when time term h is multiplied, the capacity per weight (mAh/g) or capacity per area (mAh/cm²) is obtained. As a result, the pressure change rate obtained by dividing the capacity becomes a value having a unit of [MPa/h].

According to the pressurizing system for an all-solid-state battery 10 according to the present disclosure, the pressure applied to the all-solid-state battery 10 may be varied in real-time according to the charging and discharging state of the all-solid-state battery 10. Thus, by varying the pressure applied to the all-solid-state battery 10 in real-time, the pressure is always maintained within a suitable range regardless of the charging and discharging state.

In particular, the all-solid-state battery 10 may be subjected to optimal pressure according to the charging and discharging state, and the conventional structural deterioration problem caused by repeated expansion and contraction of the cell can be solved.

In addition, it is possible to effectively prevent damage to electrodes and electrolytes due to repeated charging and discharging of all-solid-state batteries, repeated expansion and contraction of cell volume, repeated increase and decrease of cell thickness, and an internal short circuit. An overcharge phenomenon caused by the short circuit may be prevented, and an all-solid-state battery having a stable capacity may be expressed.

Although the embodiment of the present disclosure has

been described in detail herein, the scope of the present disclosure is not limited thereto. Various modifications and improvements that may be made by those having ordinary skill in the art using the basic concept of the present disclosure defined in the following claims are also included in the scope of the present disclosure.

What is claimed is:

1. A pressurizing system for an all-solid-state battery, the system comprising:
a pressurizing mechanism configured to pressurize an all-solid-state battery and adjust a pressure applied to the all-solid-state battery;
a driving device configured to drive the pressurizing mechanism; and
a controller configured to control the driving device so that the pressure applied to the all-solid-state battery by the pressurizing mechanism is adjustable and variable,
wherein when the all-solid-state battery is charged or discharged, the controller is configured to control the driving device according to a pressure change rate determined based on state information of the all-solid-state battery so that the pressure applied to the all-solid-state battery is adjusted and varied according to the pressure change rate.

2. The system of claim 1, wherein the pressurizing mechanism comprises:
a fixed plate fixedly positioned;
a movable plate provided to pressurize the all-solid-state battery disposed between the fixed plate and the movable plate, the movable plate configured to be movable by the driving device to adjust and vary the pressure applied to the all-solid-state battery; and
a guide unit configured to guide the movable plate to move along guide rods.

3. The system of claim 1, wherein the pressurizing mechanism comprises two pressurizing plates configured to pressurize the all-solid-state battery disposed therebetween,
the driving device comprises a cylinder mechanism with a piston controlled to move back and forth according to a control signal sent from the controller, and
the cylinder mechanism allows one of the two pressurizing plates to move according to a back-and-forth movement of the piston when adjusting and varying the pressure for pressurizing the all-solid-state battery.

4. The system of claim 3, wherein the driving device further comprises a fluid control device configured to control fluid supply and discharge to and from the cylinder mechanism to control the back-and-forth movement of the piston.

5. The system of claim 4, wherein the fluid control device comprises:
a fluid supply line connected to supply fluid to a main cylinder body having the piston installed therein in the cylinder mechanism;
a fluid discharge line connected to discharge the fluid from the main cylinder body;
a first delivery device installed in the fluid supply line and configured to supply the fluid to the cylinder body, the first delivery device configured to be driven by the controller;
a first valve installed in the fluid supply line and configured to perform opening and closing operations under control of the controller; and
a second valve installed in the fluid discharge line and configured to perform opening and closing operations under control of the controller.

6. The system of claim 5, wherein the fluid control device further comprises a second delivery device provided in the fluid discharge line and configured to suck in and discharge the fluid from the main cylinder body under control of the controller.

7. The system of claim 5, wherein the fluid control device further comprises a pressure gauge installed in the fluid supply line or the main cylinder body to detect the pressure of the fluid in the main cylinder body, and
the controller is configured to control the fluid control device so that fluid pressure in the cylinder body increases or decreases according to a predetermined pressure change rate based on pressure state information detected by the pressure gauge.

8. The system of claim 1, wherein the controller is configured to control the operation of the driving device to increase the pressure applied to the all-solid-state battery when charging the all-solid-state battery and configured to control the driving device to reduce the pressure applied to the all-solid-state battery when discharging the all-solid-state battery.

9. The system of claim 1, wherein the controller is configured to control the operation of the driving device to reduce the pressure applied to the all-solid-state battery when charging the all-solid-state battery and configured to control the driving device to increase the pressure applied to the all-solid-state battery when discharging the all-solid-state battery.

10. The system of claim 1, wherein the state information of the all-solid-state battery comprises a charge capacity of a previous charging process and a discharge capacity of a previous discharging process, and
wherein the controller is configured to determine a pressure change rate in a current charging process based on the charge capacity of the previous charging process and determine a pressure change rate in a current discharging process based on the discharge capacity of the previous charging process.

11. The system of claim 10, wherein a control range for the pressure to be applied to the all-solid-state battery is preset in the controller, and
wherein the controller is configured to:
determine the pressure change rate of the current charging process by dividing a difference between an upper limit pressure and a lower limit pressure in the control range by the charging capacity of the previous charging process, and
determine the pressure change rate of the current discharging process by dividing the difference between the upper limit pressure and the lower limit pressure of the control range by the discharge capacity of the previous discharging process.

12. The system of claim 1, wherein the pressure change rate is defined as a rate at which the pressure changes with respect to a state of charge (SOC) value representing a state of charge of the all-solid-state battery during charging or discharging of the all-solid-state battery.

13. The system of claim 12, wherein the controller is configured to control the driving device so that the pressure for pressurizing the all-solid-state battery linearly changes at the pressure change rate as the SOC value changes during charging or discharging of the all-solid-state battery.
